(19) United States
(12) Patent Application Publication
(10) Pub. No.: US 2016/0124081 A1
(43) Pub. Date: May 5, 2016

(54) METROLOGY METHOD AND DEVICE FOR CALIBRATING THE GEOMETRY OF A NETWORK OF UNDERWATER ACOUSTIC BEACONS

(71) Applicant: IXBLUE, Saint-German-En-Laye (FR)

(72) Inventors: Didier CHARLOT, LE RELECQ-KERHUON (FR); Sebastien PENNEC, LANDERNEAU (FR)

(21) Appl. No.: 14/895,720

(22) PCT Filed: May 28, 2014
(86) PCT No.: PCT/FR2014/051281

§ 371 Date: Dec. 3, 2015

(30) Foreign Application Priority Data
Jun. 5, 2013 (FR) 1355161

(51) Int. Cl. G01S 7/52; G01S 15/87; G01S 1/76

(52) U.S. Cl. CPC G01S 7/52004; G01S 1/76; G01S 15/874

(57) ABSTRACT

A metrology method and device for calibrating the geometry of a network of Nb stationary underwater acoustic beacons (11, 12, 13, 14) defining a field of beacons, implementing a moving body (20) including elements for receiving acoustic signals from each of the beacons of the network, respectively. The metrology method includes the following steps: acquiring Nm series of Nb acoustic measurements of the relative distance between the moving body and each beacon of the network, respectively, during a movement of the moving body; calculating a numeric function C from the series of acoustic measurements of the relative distances and parameters representing relative positions of the beacons; executing an algorithm for minimising the numeric function C in order to deduce therefrom an estimation of the values of the relative position parameters of each of the beacons of the network.

The present invention relates to the systems and methods of acoustic metrology used for the positioning of underwater structures and/or for the navigation of sea and underwater vehicles. More precisely, the invention relates to a method and a system of metrology allowing to calibrate the geometry of a network of immersed acoustic beacons and simultaneously the navigation of a sea or underwater vehicle with respect to this network of beacons.

The systems and methods of underwater acoustic metrology are commonly used to determine the relative positions and orientations of two immersed structures on which are fixed acoustic beacons.

Each acoustic beacon is provided with at least one emitter or with an acoustic transponder, adapted to emit an acoustic signal specific to each beacon.

In the present document, the acoustic beacons are supposed to be fixed with respect to each other. The acoustic beacons may be fixed on the underwater seabed or on immersed facilities such as two ends of sections of an underwater pipeline that are desired to be connected by a pipe.

In the present document, it is meant by network of beacons, or network, a plurality of immersed acoustic beacons that are spatially distributed over a field of beacons. The beacons may be located in a two- or three-dimensional field of beacons. The geometry of a network corresponds to the whole two- or three-dimensional spatial positions of each of the beacons of this network, represented for example as Cartesian coordinates (XYZ), where Z represents the depth of immersion.

The systems and methods of underwater acoustic metrology also provide measurements allowing to help for the navigation of surface or underwater vehicles equipped with acoustic emitters and/or receivers to determine the position of the vehicle with respect to a network of fixed beacons whose positions are previously calibrated.

There exist various types of systems of acoustic metrology based on the transmission of acoustic signals:
the systems of the Long Base Line (LBL) type. In an LBL system, the geometry of the network of beacons is obtained by measuring the direct distances between the beacons of the network;
the systems of the Short Base Line (SBL) or Ultra-Short Base Line (USBL) type. In a SBL or USBL system, the absolute position of each of the beacons of the network is measured by the SBL, or respectively USBL, system.

There also exist navigation systems that do not use the transmission of acoustic signals. In particular, the Inertial Navigation Systems (INS) are based on the use of an inertial unit comprising three accelerometers and three gyroscopes that integrate the measurements of acceleration and rotation to deduce therefrom the displacement of a vehicle in three-dimensions and the current position thereof with respect to a starting reference system.

Finally, there exist hybrid navigation systems that combine an inertial navigation unit and one or several other sensors of the Loch Doppler type (DVL: Doppler Velocity Log), acoustic distance measuring sensor and/or immersion depth sensor. In such an hybrid navigation system, the simultaneous measurements of the mobile and beacons positions are obtained by a processing of the data generally based on a Kalman algorithm merging the distance, speed information compensated for the measurements of attitude and/or depth of immersion.

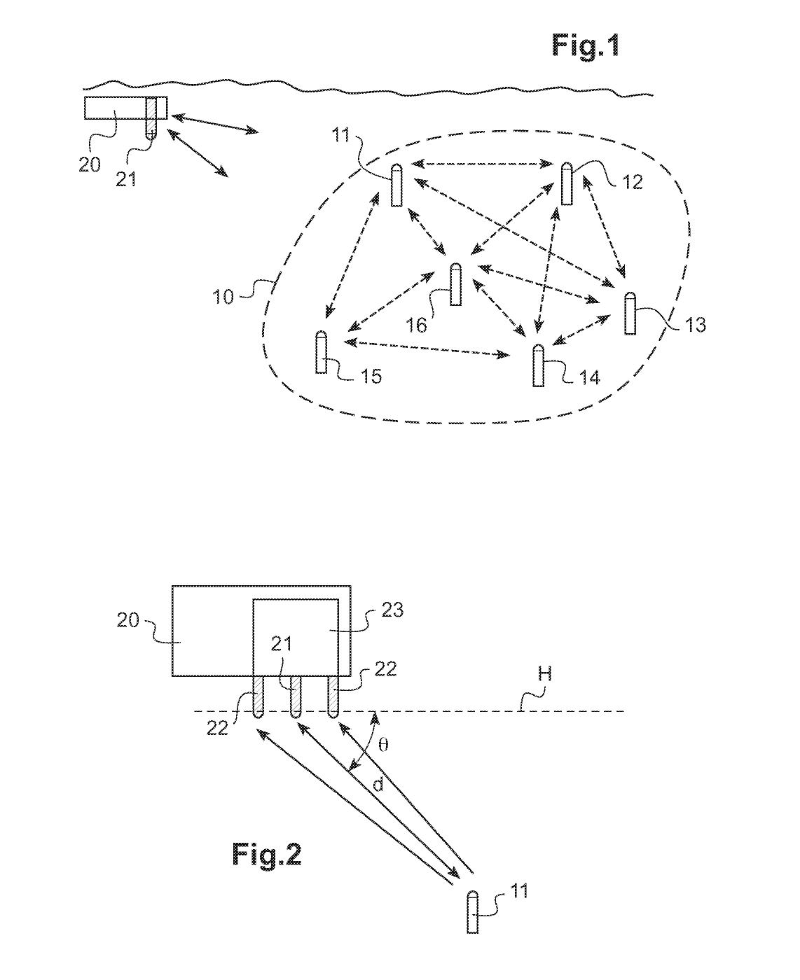

FIG. 1 schematically shows a system of the LBL type according to the prior art. The LBL system comprises a network of beacons 10 formed of fixed beacons 11, 12, 13, 14, 15, 16. A remotely operated vehicle (ROV) 20 is equipped with an on-board acoustic distance measuring device 21.

The LBL system uses only acoustic measurements of distances, or more precisely acoustic measurements of time of flight converted into distances by a multiplicative factor based on an average estimation of the celerity of the acoustic waves between the mobile and the beacons, or better, by a profile of celerity of the acoustic waves between the mobile and the beacons, the profile of celerity being in particular function of the depth of immersion of the beacons.

In a first phase, it is searched to calibrate the geometry of a network of beacons of an LBL system, i.e. to determine the relative positions of the beacons of a network comprising a number Nb of beacons, where Nb is an integer. One or several of the beacons may for example be fixed on immersed structure elements, the relative positions of which are searched to be determined, for example pipeline ends to be connected.

In an LBL system, the calibration of the beacon network geometry is obtained by a series of direct measurements of distances between the beacons. In a three-dimensional network of beacons, the first beacon 11 is arbitrarily positioned at (x1=0,y1=0,z1=0), the second beacon 12 defines one of the axes, for example the axis X, and is positioned at (0,y2,z2). The maximum number possible of direct measurements between two beacons is of: Nb*(Nb−1)/2. To determine the relative positions of the beacons of the network in three-dimensions, or in 3D mode, the number of unknowns is of 2+3*(Nb−2). In order to be able to solve the system of equations, it is hence required that Nb*(Nb−1)/2 is higher than or equal to (3*Nb)−4, which gives Nb higher than or equal to 6. In 3D mode, at least six beacons are hence required to fully determine the relative positions of the beacons of a network of an LBL system.

Similarly, it is calculated that, to calibrate the geometry of a two-dimensional network of beacons of an LBL system, or in 2D mode, i.e. a network of beacons in which all the beacons are located in a same plane, at least three beacons are required.

A system of the LBL type poses constraints of acoustic visibility of the beacons. To calibrate the network of an LBL system, all the beacons must be able to acoustically communicate with each other, two by two. The beacons must hence be positioned relative to each other in such a way that there is no obstacle to the propagation of the acoustic waves, at least during the phase of calibration. Moreover, the number Nb of beacons to be deployed is important, Nb being higher than or equal to six, as soon as the network of beacons is three-dimensional.

In navigation mode, in an LBL system, the relative position of the mobile 20 with respect to the network of beacons 10 is obtained by trilateration based on the measurements of distances between the mobile and the network of beacons. During the navigation, the mobile must be able to communicate with at least three beacons.

FIG. 2 schematically shows a system of the USBL or SLB type according to the prior art. Such a system uses measurements of distance and direction with respect to an immersed fixed beacon. In an USBL or SLB system, a mobile system 20 is provided with an acoustic emitter 21, a mini-network of acoustic sensors 22 in reception and an attitude unit 23. A beacon 11 (fixed or not) comprises an acoustic transducer adapted to receive an acoustic signal emitted by the acoustic emitter of the mobile system 20 and to emit as a response an acoustic signal detected by the mini-network of sensors 22 and by the attitude unit 23 of the mobile 20. The USBL (or SBL) system provides, for each beacon interrogated, the measurement of the distance d separating the mobile 20 from the beacon 11 and the direction with respect to a horizontal line H via the angle of inclination θ. In the calibration mode, the USBL system is coupled to a GPS system (or any other system providing an absolute position) to calibrate the absolute position of the beacon 11 interrogated. In the navigation mode, the USBL system positions itself by interrogating the fixed beacon 1, whose position is known. A single beacon 11 is sufficient for the navigation. However, the integration of an attitude unit and an acoustic sensor remains complex.

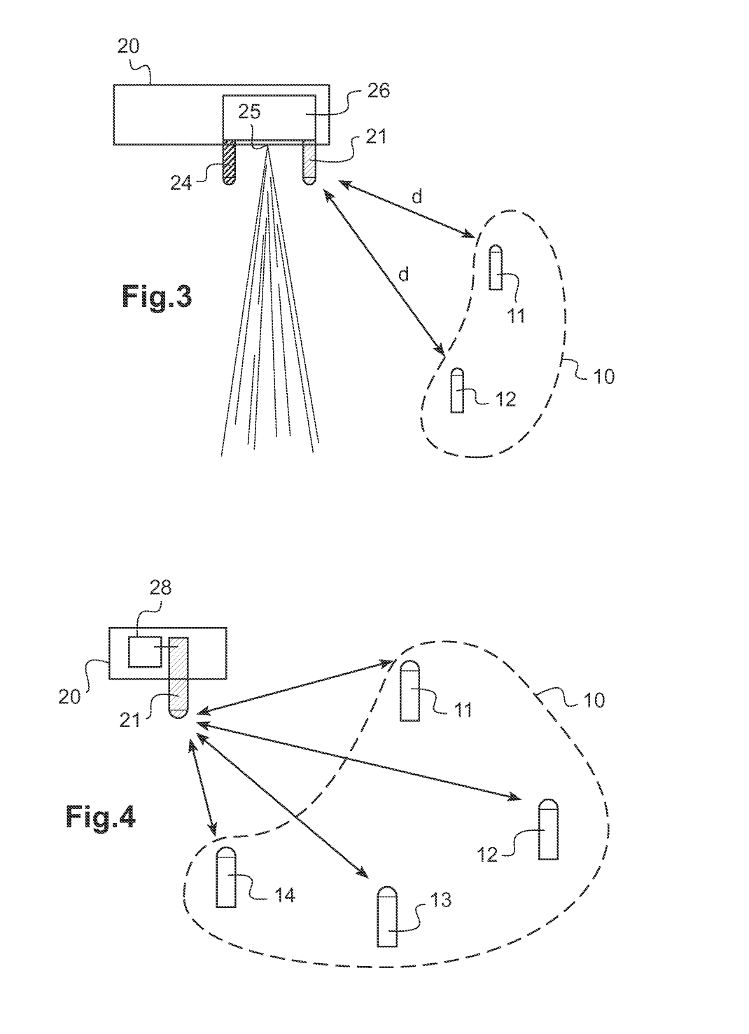

FIG. 3 schematically shows a hybrid or coupled inertial navigation system comprising an inertial navigation unit (INS) 26 coupled to at least one other sensor, for example an acoustic distance measuring sensor 21. The inertial unit 26 provides the displacement of the mobile with respect to an initial position based on the rotation measurements and by double integration of the accelerations. In a hybrid navigation system, to limit the drift of this inertial unit, the INS is coupled to one or several other systems of measurement: speed measurement 25 obtained by Lock Doppler (DVL), immersion depth sensor 24, acoustic sensor 21 for measuring the relative distance with respect to one or several beacons 11, 12 whose positions are known or not. The systems of the inertial coupled type hence use a displacement (or speed) sensor provided by the inertial unit, generally coupled to acoustic sensors for measuring distance 21, depth of immersion 24 and/or tide amplitude.

Unlike the LBL, SBL or USBL systems, an inertial coupled system determines simultaneously the estimation of the position of the mobile and the estimation of the position of the beacon(s) 11, 12 constituting the network of beacons 10. In an inertial coupled system, the calibration and the navigation are hence performed simultaneously. The algorithm implemented for the calibration and the navigation of an inertial coupled system is generally a Kalman algorithm that merges the information provided by the inertial unit 26 and the measurements of one or several auxiliary sensors to determine both the position of the mobile 20 and that of the beacons 11, 12. This type of algorithm is well known under the acronym SLAM (Simultaneous Localisation and Mapping).

Whatever the number of acoustic beacons, an inertial coupled system requires at least one inertial unit and one or several other sensors. However, an inertial coupled system remains sensitive to the drifts of the inertial unit. Moreover, the manufacturing of an inertial coupled system is relatively complex and requires a relatively long phase of alignment.

The different existing systems and methods of metrology for the calibration and the navigation are complex systems that generally integrate several different techniques of measurement. The phases of calibration of the LBL, SBL/USLB or coupled inertial systems are generally long and complex.

The present invention has for object to remedy these drawbacks and to propose a system and a method for navigation and calibration that are simpler to implement and compliant with a reduced number of sensors. More precisely, the invention proposes a method of metrology for calibrating the geometry of a network of underwater acoustic beacons, the network comprising an integer number Nb of fixed beacons and delimiting spatially a two-dimensional, or respectively three-dimensional, field of beacons, each of the acoustic beacons including means for emitting and/or receiving acoustic signals, the method of metrology implementing a mobile, the mobile including means for interrogating and receiving the acoustic signals coming from each of the beacons of the network, respectively, the method of metrology comprising the following steps:
a) acquisition of Nm series of Nb acoustic measurements of relative distance between the mobile and each of the Nb beacons of the network, respectively, with Nm an integer higher than or equal to three and Nb higher than or equal to three for a two-dimensional calibration and, respectively, Nm an integer higher than or equal to eight and Nb higher than or equal to four for a three-dimensional calibration; the acquisition of the series of acoustic measurements being performed dynamically during a displacement of the mobile to a series of Nm successive positions;
b) calculation of a numerical function C as a function on the one hand of the series of acoustic measurements of relative distance and on the other hand of variables representative of the relative positions of the beacons in the two-dimensional, or respectively three-dimensional, field of beacons;
c) execution of an algorithm of minimization of the numerical function C to deduce therefrom an estimation of the values of the variables representative of the relative positions of each of the beacons of the two-dimensional, respectively three-dimensional, network;
d) determination of the geometry of the network of beacons as a function of the estimated values of the variables representative of the relative positions of the Nb beacons of the network.

According to particular and advantageous aspects of the method of metrology for calibrating the geometry of a network of underwater acoustic beacons:

the method further includes an initial step of estimation of an approximate value of the relative positions of each beacons in the field of beacons and of estimation of an approximate value of the position of the mobile with respect to the field of beacons and the step of acquisition of the series of acoustic measurements of relative distance between the mobile and each of the Nb beacons of the network, respectively, is performed during a displacement of the mobile about the approximate position of the field of beacons;

the displacement of the mobile during the step of acquisition of measurements is performed according to a circular, elliptic or rectangular curve or portion of curve about the approximate position of the field of beacons;

the method of metrology further comprises a step of determination of the difference of depth of immersion between the beacons;

the method of metrology further comprises a measurement of the depth of immersion of each of the beacons and of the mobile;

the method of metrology comprises a step of compensation for the variations of depth of immersion of the beacons and of the mobile as a function of the tides, said compensation being preferably deduced from a tide gauge or a tide prediction model.

Particularly advantageously, the method of metrology allows simultaneously the navigation of the mobile, and the step of execution of an algorithm of minimization of the numerical function C allows to deduce therefrom an estimation of the relative position of the mobile with respect to the estimated values of the variables representative of the relative positions of the Nb beacons of the network of beacons.

According to other particular aspects, the method of metrology further comprises:

a step of filtering of the data of the Nm series of Nb acoustic measurements before the step of calculation of the numerical function C;

a step of interpolation of the data of the Nm series of Nb acoustic measurements coming from the step of acquisition, or respectively filtering, said step of interpolation being performed before the step of calculation of the numerical function C.

The invention also relates to a device of metrology for calibrating the geometry of a network of underwater acoustic beacons, the network comprising an integer number Nb of fixed beacons and delimiting spatially a field of beacons, each of the acoustic beacons including means for emitting and/or receiving acoustic signals, the device of metrology comprising a mobile, the mobile comprising means for interrogating and receiving acoustic signals coming from each of the beacons of the network, respectively.

According to the invention, the device of metrology includes a calculator configured to:
e) receive Nm series of Nb acoustic measurements of relative distance between the mobile and each beacon of the network, respectively, with Nm an integer higher than or equal to three and Nb higher than or equal to three for a two-dimensional calibration, and, respectively, Nm an integer higher than or equal to eight and Nb higher than or equal to four for a three-dimensional calibration; said series of acoustic measurements being acquired dynamically during a displacement of the mobile to a series of Nm successive positions;
f) calculate a numerical function C as a function on the one hand of the series of acoustic measurements of relative distance and on the other hand of variables representative of the relative positions of the beacons in the two-dimensional, or respectively three-dimensional, field of beacons;
g) execute an algorithm of minimization of the numerical function C to deduce therefrom an estimation of the values of the variables representative of the relative positions of each of the beacons of the two-dimensional, or respectively three-dimensional, network; and
h) determine the geometry of the network of beacons as a function of the estimated values of the variables representative of the relative positions of the Nb beacons of the network.

According to various particular and advantageous aspects of the device of metrology for calibrating the geometry of a network of underwater acoustic beacons, the calculator is further configured to:
i) digitally filter the data of the Nm series of at least Nb acoustic measurements;
j) interpolate the filtered data of said Nm series of Nb acoustic measurements of relative distance before calculating the numerical function C;

simultaneously estimate the relative position of the mobile and the positions of the beacons at the step of minimization of the numerical function C to allow simultaneously the calibration of the geometry of the network of underwater acoustic beacons and the navigation of the mobile.

Advantageously, the device of metrology further comprises a sensor for the depth of immersion of the mobile and means for measuring the immersion depth difference between the beacons or means for measuring the depth of immersion of each of the beacons; and/or a tide gauge or means for calculating the tide amplitude adapted to compensate for the variations of depth of immersion of the mobile and of the beacons as a function of the tides.

The invention will find a particularly advantageous application in the calibration of a network of acoustic beacons and in the navigation of a remote-controlled surface or underwater vehicle.

The invention advantageously allows to calibrate the geometry of a network of beacons with no reference to an absolute device of metrology (GPS type or other), while ensuring simultaneously the navigation of a mobile with respect to this network of beacons.

The present invention also relates to the characteristics that will become apparent from the following description and that will have to be considered in isolation or according to any of their technically possible combinations.

This description given by way of non-limitative example will allow to better understand how the invention may be implemented with reference to the appended drawings in which:

FIG. 1 schematically shows a navigation system of the LBL type according to the prior art;

FIG. 2 schematically shows a navigation system of the USBL or SBL type according to the prior art;

FIG. 3 shows a navigation system of the inertial coupled type comprising an inertial navigation unit (INS) coupled to at least one other sensor;

FIG. 4 shows a 3D positioning system according an embodiment of the invention;

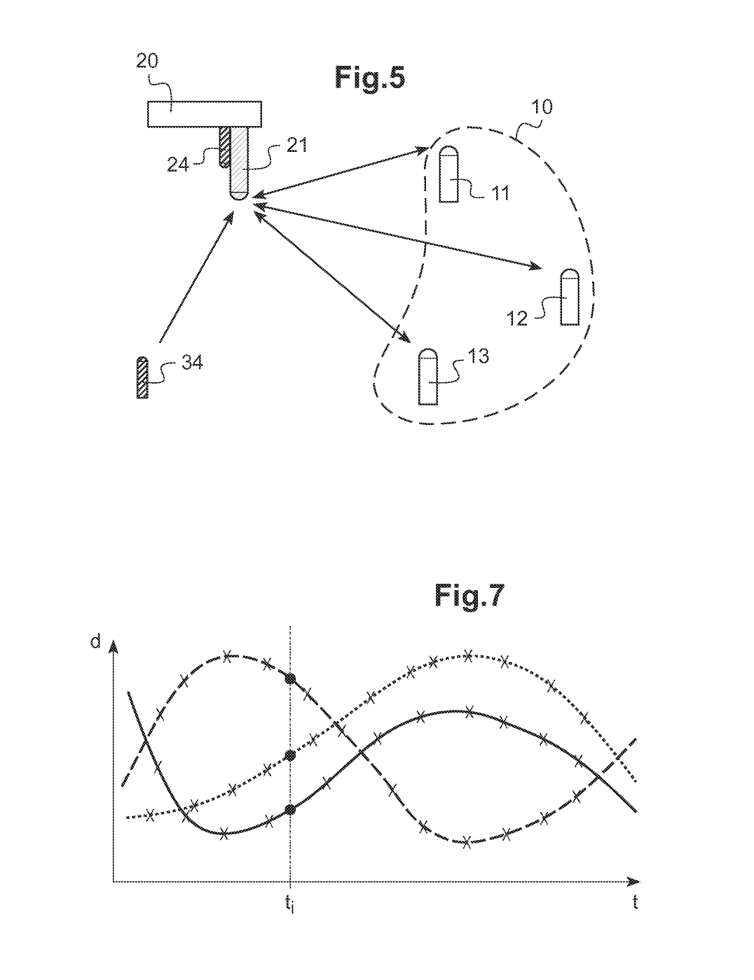

FIG. 5 shows a 2D positioning system according to another embodiment of the invention;

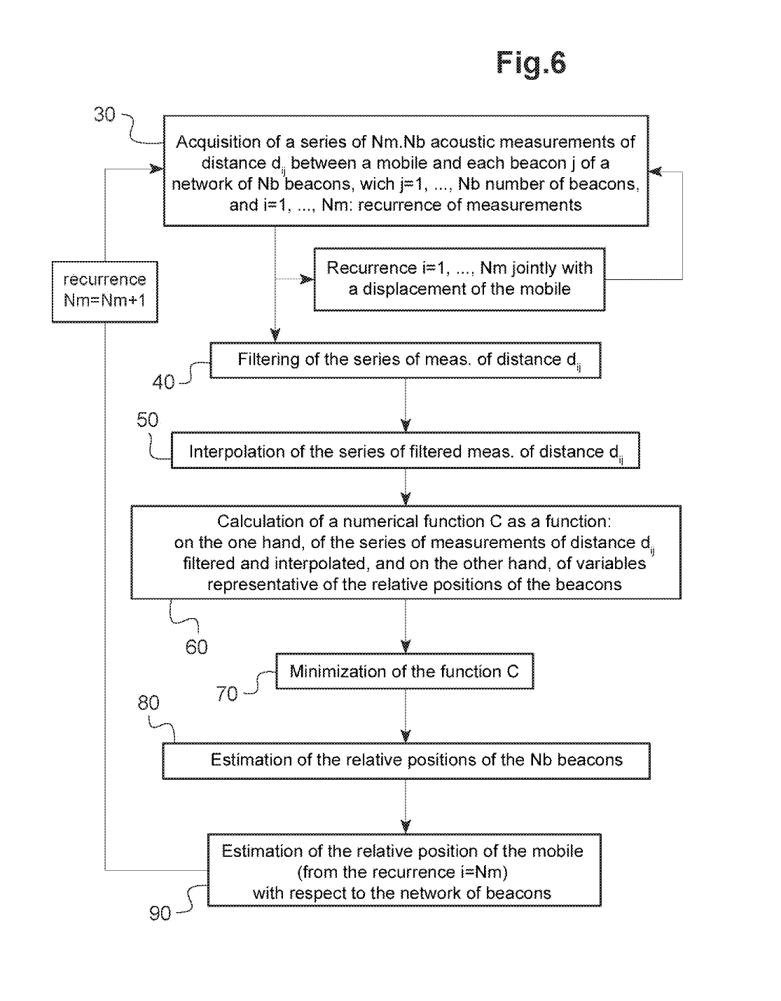

FIG. 6 schematically shows a synopsis of a navigation and calibration processing algorithm according to the invention;

FIG. 7 shows an example of a series of measurements of distances of a mobile with respect to a three-beacon network as a function of time;

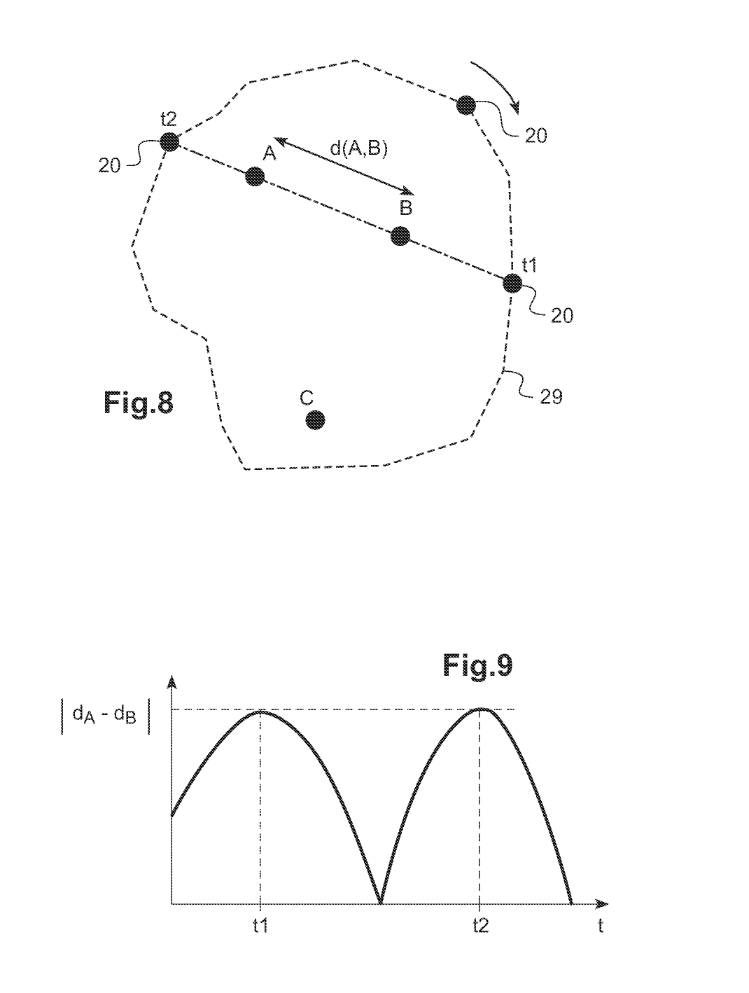

FIG. 8 schematically shows a two-dimensional map illustrating the trajectory of a mobile about a field of beacons to determine approximately the positions of the beacons;

FIG. 9 shows a measurement of the differences of distances between two beacons A and B during a trajectory of the mobile as illustrated in FIG. 8.

### DEVICE

FIG. 4 shows a 3D underwater acoustic metrology device according to an embodiment of the invention.

In its simplest 3D version, a mobile 20 includes a calculator 28 and at least one acoustic distance sensor or distance measuring device 21 adapted to interrogate a network 10 of fixed acoustic beacons 11, 12, 13, 14.

As an alternative, the device may also operate in “pinger” mode where the beacons emit acoustic signals at a predefined rate, synchronously with a reference clock, and the mobile receives the signals emitted by the beacons, as well as the reference clock signal.

The calculator 28 is configured so as to execute the computer implementation of a 3D-mode algorithm that estimates simultaneously the geometry in three dimensions of the network of acoustic beacons 11, 12, 13, 14 and the position in three dimensions of the mobile 20 with respect to the beacons 11, 12, 13, 14.

As detailed hereinafter, in 3D mode, a minimum of four acoustic beacons 11, 12, 13, 14 is required. Advantageously, the distance measuring device 21 emits a common acoustic signal of interrogation and each beacon 11, 12, 13, 14 responds with its own code. The distance measuring device 21 hence measures the distances d₁, d₂, d₃ and d₄ between the mobile 20 and each of the beacons 11, 12, 13, 14, respectively, at a series of instants t or measurement recurrences. The 3D-mode algorithm can use only acoustic measurements. The 3D-mode device requires no other additional sensor, such as an inertial unit, an attitude unit or a Lock Doppler (DVL).

In a two-dimensional, or 2D, variant, described in relation to FIG. 5, the network of beacons 10 includes three fixed beacons 11, 12, 13. The network of beacons is two-dimensional, the three beacons being contained in a same plane and not aligned. The mobile system 20 includes a calculator 28, a distance measuring device 21. The mobile system 20 is further provided with an immersion sensor 24. The depth of immersion of the beacons 11, 12, 13 is supposed to be known. In 2D mode, the calculator 28 is configured to execute the computer implementation of a 2D-mode algorithm that estimates simultaneously, in horizontal projection, the geometry of the network 10 of beacons and the position of the mobile 20 with respect to the beacons. If the measurement is performed in a place subjected to tide variations, it is required to adjoin an immersion sensor 34 located at a fixed position and that registers or transmits the value of the depth of immersion to this sensor as a function of the variations due to the tides or, in a variant, to use beacons provided with an immersion sensor and able to transmit this information to the mobile by a telemetry means.

There exists a third variant interesting from a practical point of view, which is identical to the 2D version, but for which the immersion of the mobile is not measured; only the relative depths of immersion between beacons, i.e. the difference of depth of immersion between the beacons, are known. In the present document, this variant is called: 2D ½ mode. The difference of depth of immersion between beacons may be determined at the time of installation of the beacons, for example. Once the plane of the beacons known, it is sufficient to measure the altitude ΔZ of the mobile 20 with respect to the plane of the beacons.

Method

The 2D mode of operation of the method and of a system of metrology according to an embodiment of the invention will now be described in more detail.

FIG. 6 schematically shows an example of algorithm of acquisition and processing according to an embodiment of the invention to allow calibrating the geometry of a network of beacons and helping the navigation of a mobile by providing the relative position of the mobile with respect to this network of beacons.

The method of metrology includes the following steps:
a step 30 of acquisition of a series of distance measurements;
a step 40 of filtering of the data (optional);
a step 50 of interpolation, for example linear, of the distances (optional);
a step 60 of calculation of a numerical function C as a function on the one hand of the series of distance measurements, preferably filtered and interpolated, and on the other hand of variables representative of the relative positions of the beacons of the network;
a step 70 of minimisation of the numerical function C;
a step 80 of estimation of the geometry of the network of beacons;
a step 90 of estimation of the mobile position with respect to the network of beacons.

The calibration mode operates dynamically during a displacement of the mobile system 20.

Unlike an LBL system, according to the method of the invention, the calibration is performed at the same time as the navigation.

The method of metrology hence combines the calibration and navigation modes.

The method is then applied recursively, new acquisitions of data allowing on the one hand to refine if necessary the estimation of the geometry of the network of beacons and on the other hand to determine a new estimation of the position of the mobile.

Once the geometry of the network of beacons determined with a sufficient accuracy, the navigation of the mobile can also be performed by a conventional algorithm of trilateration.

1. Data Acquisition

At step 30, the mobile system 20 acquires N series of acoustic measurements of distances d₁, d₂, d₃ . . . d_{N} between the mobile 20 and each of the beacons 11, 12, 13 . . . , respectively, of the network of beacons 10, as a function of time.

More precisely, a first series of measurements of distance between the mobile and the first beacon 11 is acquired for a series of measurement recurrences, during the displacement of the mobile. Simultaneously, a second series of measurements of distance between the mobile and the second beacon 12 is acquired for a series of measurement recurrences, during the same displacement of the mobile. Likewise, simultaneously for each of the Nb beacons.

N series of Nb measurements of distance between the mobile and each of the Nb beacons of the network are hence acquired as a function of time, during the displacement of the mobile.

The acoustic distance measurements are conventionally performed based on the acoustic measurements of time of flight, taking into account the celerity of the sea environment, or, preferably, the profile of celerity between the sensor 21 and the beacons 11, 12, 13, 14.

Let's note Nm the number of positions of the mobile as a function of time and Nb the number of acoustic beacons 1, 2, 3, possibly 4. The number Nm of recurrences or points of measurement must be higher than a minimum value made explicit in the following paragraphs. The more Nm increases, the more the redundancy of the distance measurement increases and in fine the more the accuracy of the measurements increases.

Hence, Nb series of Nm recurrences are available, forming a series of Nm.Nb acoustic distance measurements for Nm variable positions of the mobile with respect to the network of beacons.

Let's determine the minimum number of points of this series of Nm.Nb measurements.

Let's note Nm the number of recurrences corresponding to as many successive positions of the mobile and Nb the number of beacons. Nm and Nb are positive integers.

In 3D mode, it is searched to solve a system of equations such as:

Nb*Nm≧3Nm+2+3*(Nb−2),

hence Nm≧(3*Nb−4)/(Nb−3).

In 3D mode, it is deduced therefrom that the number Nb of beacons is higher than or equal to 4.

In the case where the number Nb of beacons is equal to 4, it is deduced therefrom that the number Nm of recurrences is higher than or equal to 8. The minimum number of points of the series of acoustic measurements in 3D mode is hence of 32, for 4 beacons.

In 2D mode, it is searched to solve the system of equations such as:

Nb*Nm≧2Nm+1+2*(Nb−2) i.e. Nm≧(2*Nb−3)/(Nb−2),

i.e. Nb≧3 and for Nb=3, Nm≧3.

In 2D mode, it is deduced therefrom that the number Nb of beacons is higher than or equal to 3. In the case where the number Nb of beacons is equal to 3, it is deduced therefrom that the number Nm of recurrences is higher than or equal to 3. The minimum number of points of the series of acoustic measurements in 2D mode is hence of 9, for 3 beacons.

In 2D ½ mode, it is searched to solve the system of equations such that:

Nb*Nm≧3Nm+2+2*(Nb−2) i.e. Nm≧(2*Nb−2)/(Nb−3),

i.e. Nb≧4 and for Nb=4, Nm≧6.

In 2D ½ mode, it is deduced therefrom that the number Nb of beacons is higher than or equal to 4. In the case where the number Nb of beacons is equal to 4, it is deduced therefrom that the number Nm of recurrences is higher than or equal to 6. The minimum number of points of the series of acoustic measurements in 2D ½ mode is hence of 24, for 4 beacons.

The minimum number of beacons is hence of four in 2D ½ or 3D mode, and of three in 2D mode.

The method of calibration uses a series of independent acoustic measurements corresponding to variable positons of the mobile 20 with respect to the network of beacons to determine the geometry of the network of beacons. Contrary to the prior devices and methods, the mobile 20 is in move during the procedure of calibration. The mobile being in move, the series of measurements acquired over time represents a series of measurements at variable positions of the mobile 20 with respect to the network of beacons.

In this dynamic acquisition mode, it is however necessary that the mobile does not move too fast otherwise a bias would be introduced and would partially distort the measurement.

2. Measurement Filtering (Optional Step)

To improve the accuracy of the measurements, it is preferable (but not necessary) to perform the step 40 of distance measurement filtering, which has for object to reject the aberrant acoustic measurements caused for example by multipath travels of the acoustic waves between the mobile 20 and an acoustic beacon. A simple means is to define a maximum speed Vmax of the mobile and to reject the couples of distances measured at a same beacon (d(t1),d(t₂)) over a time interval dT=(t₂−t₁) for which the ratio:

abs(d(t₂)−d(t₁))/dT>Vmax.

Typically for an underwater mobile performing measurements, the order of magnitude of Vmax is of 1 to 2 m/s.

The step 40 of measurement filtering hence allows to eliminate the aberrant points of acoustic measurements of distances between the mobile and each of the beacons.

3. Distance Interpolation (Optional Step)

To increase the accuracy of measurement, it is preferable (but not necessary) to execute the step 50 of interpolation, which has for object to provide measurements of distances of the mobile with respect to each of the beacons at a same instant t, whatever the distance between the mobile and these beacons.

The interpolation may for example be linear. Any other method of parabolic, polynomial, using-the-spline-functions interpolation is suitable.

Let's Dmax be the maximum distance between two beacons 11, 12 of the network to be calibrated. As a response to an interrogation signal emitted by the distance measuring device 21, the two acoustic signals coming from these two beacons reach the distance measuring device 21 with a time interval lower than or equal to dT=2*Dmax/C. During this time dT, the mobile moves by 2*Dmax*V/c. By taking for the mobile speed V=1 m/s, the celerity of the acoustic waves in water C=1500 m/s and the distance Dmax=150 m, a time interval dT =0.2 s and a maximum displacement of the mobile of 20 cm are obtained. If the speed of the mobile 20 is constant in direction and norm during dT, the error made by linear interpolation of the distance at step 50 is negligible: so to obtain an accuracy of 2 cm, it is sufficient to have a non-linearity<10%.

Example of Filtered and Interpolated Series of Measurements

By way of illustrative example, FIG. 7 schematically shows distance measurements between a mobile and three acoustic beacons as a function of time, after filtering of the acoustic data and interpolation between measurement points of a series of measurements, shown by crosses.

To free from the variation of position of the mobile during the reception of the different acoustic signals coming from the different beacons, respectively, the distances measured are interpolated at a same instant of reception (see FIG. 7).

More precisely, in FIG. 7, the curve in dotted line shows the measurement of distance between the mobile and a first beacon 11 after filtering and interpolation; the curve in full line shows the measurement of distance between the mobile and a second beacon 12 after filtering and interpolation; the curve in dashed line shows the measurement of distance between the mobile and a third beacon 13 after filtering and interpolation. The three circles respectively correspond to a measurement of one of the three distances interpolated at an instant tᵢ.

The step of interpolation allows to replace the aberrant points that have been eliminated at the step of filtering by interpolated measurement points.

Moreover, the step of interpolation allows to provide measurements of distance from the mobile to the different beacons, at a same arbitrary instant t, although the instants of arrival of the different acoustic signals of the different beacons are generally all different.

We hence have Nb series of measurements of distance from the mobile to each of the beacons of the network of beacons, at a series of instants tᵢ. Typically, the time interval between two measurements is chosen of the order of one second for a series of measurements able to reach a few hundreds or even thousands of recurrences, which corresponds to a duration of acquisition of typically a few tens of minutes. The minimum number Nm of points of the series of measurements is higher than or equal to 8 in 3D mode, and respectively higher than or equal to 3 in 2D mode, as detailed in the paragraph detailing the data acquisition.

The series of interpolated distance measurements comprises at least one series of Nm distance measurement for each beacon of the network.

The maximum number Nm of points of measurement is, as indicated hereinabove, of the order of a few hundreds or even thousands of measurements.

The redundancy and the accuracy of the measurements increase with the number Nm.

4. Estimation of the Geometry of the Network of Beacons

Calibration Mode

Step 60 of Calculation of a Mathematical Function C

In the calibration mode, the calculator searches to determine the geometry of the network of beacons without knowing the position of the mobile.

Let's consider herein the 2D mode for which the depths of immersion of the beacons and of the mobile 20 are supposed to be known. Let's consider a network of beacons 10 consisted of three beacons 11, 12, 13, which is the minimum in 2D mode. Let's B1(0,0), B2(0,y2), B3(x3,y3) be the respective coordinates of the three beacons. The unknowns of the system are then the three parameters (y2,x3,y3). The measurements are the three measured distances d1(t), d2(t), d3(t) interpolated at each instant of reception.

The step 60 is based on the execution of the computer implementation of an algorithm for determining the positions of the beacons. This algorithm is based on the calculation and the minimization of a mathematical function, conventionally called the cost function C(y2,x3,y3) for a series of measurements at a series of instants tᵢ.

In the 2D case, with a three-beacon network, the cost function is obtained by eliminating the coordinates (x, y) of the mobile between the three equations obtained at each recurrence i, each recurrence corresponding to an instant tᵢ:

$$\begin{matrix}\begin{matrix}{d}_{1}^{2} = {x}^{2} + {y}^{2} \\ {d}_{2}^{2} = {x}^{2} + ( y - {y}_{2}^{2} )\end{matrix} \\ {d}_{3}^{2} = {( x - {x}_{3} )}^{2} + {( y - {y}_{3} )}^{2}\end{matrix} \} ⇒ \begin{matrix}\begin{matrix}y = \frac{{d}_{1}^{2} + {y}_{2}^{2} - {d}_{2}^{2}}{2 {y}_{2}} \\ x = \frac{{d}_{1}^{2} + {x}_{3}^{2} + {y}_{3}^{2} - {d}_{3}^{2} - 2 {yy}_{3}}{2 {x}_{3}}\end{matrix} \\ {x}^{2} + {y}^{2} - {d}_{1}^{2} = 0\end{matrix} \qquad \begin{matrix}\begin{matrix}\begin{matrix}\begin{matrix}Eq . 1. a \\ \end{matrix} \\ Eq . 1. b\end{matrix} \\ \end{matrix} \\ Eq . 1. c\end{matrix}$$

The global cost function to be minimized is then written by reporting the Eq. 1.a and 1.b into 1.c:

$$C ( {y}_{2} , {x}_{3} , {y}_{3} ) = {\sum }_{i} {[ \begin{matrix}{[ {d}_{1}^{2} ( i ) + {x}_{3}^{2} + {y}_{3}^{2} - {d}_{3}^{2} ( i ) - ( {d}_{1}^{2} ( i ) + {y}_{2}^{2} - {d}_{2}^{2} ( i ) ) {y}_{3} ]}^{2} + \\ {[ \frac{{d}_{1}^{2} ( i ) + {y}_{2}^{2} - {d}_{2}^{2} ( i )}{2 {y}_{2}} ]}^{2} - {d}_{1}^{2} ( i )\end{matrix} ]}^{2}$$

with i the recurrence index, i being comprised between 1 and Nm

and

$$( {\hat{y}}_{2} , {\hat{x}}_{3} , {\hat{y}}_{3} ) = {argmin}_{{y}_{2} , {x}_{3} , {y}_{3}} [ C ( {y}_{2} , {x}_{3} , {y}_{3} ) ] \qquad Eq 2$$

The global cost function C is independent of the coordinates (x,y) of the mobile.

At step 70, the calculator 28 performs the minimization of this cost function. A know minimization algorithm is used, for example, such as a gradient minimization algorithm of the Levenberg Marquart type, or a generic global minimization method of the Monte Carlo type. The convergence is all the more rapid that the initial values of position of the beacons are accurate. In the case where the information of initial position of the beacons is not available, a procedure of initialization must be carried out. A simple method of obtaining the initial estimations of the beacon positions is described hereinafter in the paragraph “Beacon position initialization mode”.

The result of this minimization provides an estimation of the relative positions of the Nb beacons of the network in the reference system of the network of beacons. The calibration of the network of beacons is hence obtained (step 80).

The calibration mode operates dynamically, i.e. during the displacement of the mobile system 20.

The approximate position of the network of beacons is generally known with an accuracy of a few metres or a few tens of metres before beginning the calibration.

Preferably, the displacement of the mobile during the calibration is performed according to a trajectory that surrounds the field of beacons, i.e. a spatial area comprising all the beacons of the network, whose position is approximately known. The trajectory of the mobile is preferably symmetrical about the network of beacons, for example circular, or squared. In 3D mode, we must be ensured that the mobile does not navigate in the plane of the beacons. This trajectory about the network of beacons allows to reduce the errors of bias with respect to each of the beacons: a bias induced by a bad measurement of the immersion or the celerity for example. Indeed, to convert the measurements of time of flight into acoustic distance, an average celerity is generally used. The trajectory about the network of beacons hence allows to average the errors due to the average celerity.

For the operational needs of positioning of the underwater structures, the distance between the transponders of the network beacons is generally comprised between 20 metres and about one hundred of metres. The distance between the mobile and the network of beacons is generally lower than a few hundreds of metres.

The method of calibration of the invention allows to estimate the relative position of the beacons with an accuracy of the order of 5 to 10 centimetres, independently of the distance between the mobile and the network of beacons.

During the trajectory of the mobile about the network of beacons, all the beacons are not necessarily acoustically visible from the mobile, the aberrant points of measurement being filtered by the processing algorithm and replaced by interpolated points.

According to the method of acoustic metrology detailed hereinabove, the calibration of the geometry of the network of beacons requires no direct measurement of distance between the beacons.

The calibration method hence imposes no constraint of acoustic visibility between the beacons.

The 3D and 2D ½ modes may be generalized from the 2D mode.

In the 2D ½ mode, the unknowns are the 3D position (x,y,z) of the mobile with respect to the field of beacons and the 2D geometry of the network of beacons. We have seen hereinabove that it is required to have at least 4 beacons. The first beacon B1 is the reference beacon. Let's B1(0,0,0), B2(0,y2,z2), B3(x3,y3,z3) and B4(x4,y4,z4) be the coordinates of the 4 beacons. As explained hereinabove, in 2D ½ mode, the relative depths of immersion between the beacons are supposed to be known: the values of z2, z3 and z4 are hence supposed to be known. The unknowns of the system are then the 5 parameters (y2,x3,y3,x4,y4). The cost function is obtained by eliminating the coordinates (x,y,z) of the mobile between the four equations obtained at each recurrence:

$$\begin{matrix}\begin{matrix}\begin{matrix}{d}_{1}^{2} = {x}^{2} + {y}^{2} + {z}^{2} \\ {d}_{2}^{2} = {x}^{2} + {( y - {y}_{2} )}^{2} + {( z - {z}_{2} )}^{2}\end{matrix} \\ {d}_{3}^{2} = {( x - {x}_{3} )}^{2} + {( y - {y}_{3} )}^{2} + {( z - {z}_{3} )}^{2}\end{matrix} \\ {d}_{4}^{2} = {( x - {x}_{4} )}^{2} + {( y - {y}_{4} )}^{2} + {( z - {z}_{4} )}^{2}\end{matrix} \} ⇒ \{ \begin{matrix}[ \begin{matrix}x \\ y \\ z\end{matrix} ] = {M}^{- 1} [ \begin{matrix}{d}_{2}^{2} - {d}_{1}^{2} \\ {d}_{3}^{2} - {d}_{1}^{2} \\ {d}_{4}^{2} - {d}_{1}^{2}\end{matrix} ] \\ with M = - 2 [ \begin{matrix}0 & {y}_{2} & {z}_{2} \\ {x}_{3} & {y}_{3} & {z}_{3} \\ {x}_{4} & {y}_{4} & {z}_{4}\end{matrix} ] \\ {x}^{2} + {y}^{2} + {z}^{2} = {d}_{1}^{2}\end{matrix} \qquad Eq . 2. a$$

And the global cost function to be minimized may finally be written:

$${C}_{3 D} ( {y}_{2} , {x}_{3} , {y}_{3} , {x}_{4} , {y}_{4} ) = {\sum }_{i} {[ {Δ}_{i}^{T} A {Δ}_{i} - {d}_{1}^{2} ( i ) ]}^{2} \\ with \\ Δ = {[ \begin{matrix}{d}_{2}^{2} - {d}_{1}^{2} & {d}_{3}^{2} - {d}_{1}^{2} & {d}_{4}^{2} - {d}_{1}^{2}\end{matrix} ]}^{T} \\ A = {( {M}^{- 1} )}^{T} {M}^{- 1} \\ ( {\hat{y}}_{2} , {\hat{x}}_{3} , {\hat{y}}_{3} , {\hat{x}}_{4} , {\hat{y}}_{4} ) = {argmin}_{{y}_{2} , {x}_{3} , {y}_{3 ,} , {x}_{4} , {y}_{4}} [ {C}_{3 D} ( {y}_{2} , {x}_{3} , {y}_{3} , {x}_{4} , {y}_{4} ) ] \qquad Eq 2. b$$

In the 3D mode, the unknowns are the 3D position (x,y,z) of the mobile with respect to the field of beacons and the 3D geometry of the network of beacons. We have seen hereinabove that it was required to have at least 4 beacons. The first beacon B1 is the reference beacon. Let's hence B1(0,0,0), B2(0,y2,z2), B3(x3,y3,z3) and B4(x4,y4,z4) be the coordinates of the 4 beacons, the unknowns of the system are then the 8 parameters (y2,z2,x3,y3,z3,x4,y4,z4). The cost function is obtained by eliminating the coordinates (x,y,z) of the mobile between the four equations obtained at each recurrence. The equations are identical to the previous case in 2D ½ mode.

And we have:

$$( {\hat{y}}_{2} , {\hat{z}}_{2} , {\hat{x}}_{3} , {\hat{y}}_{3} , {\hat{z}}_{3} , {\hat{x}}_{4} , {\hat{y}}_{4} , {\hat{z}}_{4} ) = {argmin}_{{y}_{2} , {z}_{2} , {x}_{3} , {y}_{3} , {z}_{3} , {x}_{4} , {y}_{4} , {z}_{4}} [ {C}_{3 D} ( {y}_{2} , {z}_{2} , {x}_{3} , {y}_{3} , {z}_{3} , {x}_{4} , {y}_{4} , {z}_{4} ) ]$$

Beacon Position Initialization Mode

In the calibration procedure described hereinabove, the position of the beacons is obtained by minimization of a cost function. To ensure the convergence, it is preferable to have a good estimation of the initial values of position of the beacons. In the applications of metrology, the geometries of the offshore structures are known to within a few metres at worst, which is enough.

In the case where the positions of the beacons are not known a priori, the FIGS. 8 and 9 illustrate a simple method for determining them. In a first phase, the mobile 20 carries out a trajectory 29, shown in dotted line in FIG. 8, which includes the whole field of beacons, while performing a measurement of the differences of the distances between beacons along this trajectory 29, as described. In FIG. 8, the mobile 20 describes a trajectory 29 about the three beacons A, B, C in the direction indicated by the arrow. FIG. 9 shows the measurement in absolute value of the difference of distance between the beacons A and B: |dA−dB|. It is observed that the difference of the distances dA−dB passes, at two instants t₁ and t₂, by maxima whose value is a good approximation of the inter-beacon distance d(A,B). In FIG. 8, the mobile 20 is also shown at the instants t₁ and t₂, which respectively correspond to the maxima of |dA−dB|. These maxima also correspond to a geometry where the mobile is on a straight line passing by the positions of the beacons A and B. The same method applies to determine the distance between the beacons A and C, and respectively the distance between the beacons B and C. Hence knowing the three distances between pairs of beacons, a first approximation of the position of the beacons is deduced therefrom.

Simultaneous Navigation and Calibration Mode

From the moment when a minimum number of measurements has been performed, which is equal to N_min=(3*Nb−4)/(Nb−3) in 3D mode and N_min=(2*Nb−3)/(Nb−2) in 2D mode, at each new interrogation, the calculator of the system may update the position of the network by means of the equations (Eq 1.a and Eq 1.b) and, based on this new estimate of the network geometry, provide an estimation of the mobile position by applying for example the equation Eq 1.a (step 90).

Navigation Mode

Let's suppose the geometry of the network of beacons determined by the calibration procedure described hereinabove. The position of the mobile at a given instant is conventionally obtained by trilateration with the measurements of distances. The trilateration algorithms are known from the one skilled in the art.

For applications of metrology, the device of metrology of the invention has the advantage to allow the calibration of a network of beacons by using only measurements of distances, or more precisely measurements of time of flight between a mobile equipped with distance measuring device interrogating a network of fixed beacons.

In a variant, the mobile is also equipped with an immersion sensor, wherein the device can use measurements of distances combined to measurements of depth of immersion.

By a suitable algorithm, the device estimates simultaneously the geometry of the network of fixed beacons (calibration metrology function) and the position of the mobile with respect to the network (navigation function). No knowledge a priori about the position of the beacons and of the mobile is required. The system estimates the position of the mobile and the geometry of the network by moving about and/or inside the field of beacons.

The proposed device offers to the function of metrology notable advantages compared to the different prior devices.

In comparison with an LBL device, the device of metrology of the invention offers a greatest simplicity and rapidity of implementation. Firstly, in the device of the invention, the acoustic beacons of the network may be arranged with no constraint of acoustic visibility between the beacons. On the contrary, in a device of the LBL type, all the beacons of the network must be arranged so as to communicate between each other two by two for the calibration. Secondly, the device of the invention may operate with a network including a smaller number of beacons deployed. In 3D mode, only four beacons are required according to the invention, instead of at least six beacons in an LBL system in 3D mode. In 2D mode, the device of the invention requires the same minimum number of three beacons as a 2D LBL device. The device of the invention is however not limited to a number Nb of beacons and can operate with a network of beacons comprising more beacons than the minimum number of beacons defined hereinabove as a function of the configuration in 2D, 2D ½ or 3D mode.

The device of the invention hence imposes less constraints of relative positions of the acoustic beacons while offering the possibility to perform simultaneously the calibration of a network of beacons and the navigation of a mobile.

Comparatively to an inertial coupled system, the system of metrology of the invention offers a greatest simplicity: the device of the invention does not necessarily require a DVL Loch Doppler or immersion sensor, or a tide gauge, if four 3D-mode beacons are deployed.

Comparatively to the USBL and SLB systems, the system of metrology of the invention also offers a greatest simplicity, because it requires no attitude unit.

The method of the invention may advantageously be implemented on old acoustic devices of the LBL type, for example, in replacement of another method of calibration and/or navigation.

The device and the method of the invention offer a resolution of the centimetre order, which is sufficient for the applications of positioning of immersed structures equipped with beacons and for the navigation of a mobile, and allows to perform a calibration within a short period of time, typically less than one hour. A device of the LBL type offers a better resolution, typically of the order of one millimetre, but within a far longer period of time, of the order of 24 h. Hence, the system allows to rapidly reach a resolution that is of course lower than that of a device of the LBL type, but that is generally sufficient for the intended applications.

1-14. (canceled)

15. A method of metrology for calibrating the geometry of a network of underwater acoustic beacons, the network comprising an integer number Nb of fixed beacons and delimiting spatially a two-dimensional, or respectively three-dimensional, field of beacons, each of the acoustic beacons including means for emitting and/or receiving acoustic signals, the method of metrology implementing a mobile, the mobile including means for interrogating and receiving the acoustic signals coming from each of the beacons of the network, respectively, the method of metrology comprising the following steps:
a) acquisition of Nm series of Nb acoustic measurements of relative distance between the mobile and each of the Nb beacons of the network, respectively, with Nm an integer higher than or equal to three and Nb higher than or equal to three for a two-dimensional calibration, and respectively Nm an integer higher than or equal to eight and Nb higher than or equal to four for a three-dimensional calibration; the acquisition of the series of acoustic measurements being performed dynamically during a displacement of the mobile to a series of Nm successive positions;
b) calculation of a numerical function C as a function, on the one hand, of the series of acoustic measurements of relative distance and, on the other hand, of variables representative of the relative positions of the beacons in the two-dimensional, respectively three-dimensional, field of beacons;
c) execution of an algorithm of minimization of the numerical function C to deduce therefrom an estimation of the values of the variables representative of the relative positions of each of the beacons of the two-dimensional, respectively three-dimensional, field of beacons;
d) determination of the geometry of the network of beacons as a function of the estimated values of the variables representative of the relative positions of the Nb beacons of the network.

16. The method of metrology according to claim 15, including an initial step of estimation of an approximate value of the relative positions of each beacon in the field of beacons and of estimation of an approximate value of the position of the mobile with respect to the field of beacons and wherein the step of acquisition of the series of acoustic measurements of relative distance between the mobile and each of the Nb beacons of the network, respectively, is performed during a displacement of the mobile about the approximate position of the field of beacons.

17. The method of metrology according to claim 16, wherein the displacement of the mobile during the step of acquisition of measurements is performed according to a circular, elliptic or rectangular curve or portion of curve about the approximate position of the field of beacons.

18. The method of metrology according to claim 15, further comprising a step of determination of the difference of depth of immersion between the beacons.

19. The method of metrology according to claim 15, further comprising a measurement of the depth of immersion of each of the beacons and of the mobile.

20. The method of metrology according to claim 19, further comprising a step of compensation for the variations of depth of immersion of the beacons and of the mobile as a function of the tides, said compensation coming preferably from a tide gauge or a tide prediction model.

21. The method of metrology according to claim 15, said method of metrology allowing simultaneously the navigation of the mobile, in which the step of execution of an algorithm of minimization of the numerical function C allows to deduce therefrom an estimation of the relative position of the mobile with respect to the estimated values of the variables representative of the relative positions of the Nb beacons of the network of beacons.

22. The method of metrology according to claim 15, further comprising a step of filtering of the data of the Nm series of Nb acoustic measurements before the step of calculation of the numerical function C.

23. The method of metrology according to claim 15, further comprising a step of interpolation of the data of the Nm series of Nb acoustic measurements coming from the step of acquisition, or respectively filtering, said step of interpolation being performed before the step of calculation of the numerical function C.

24. A device of metrology for calibrating the geometry of a network of underwater acoustic beacons, the network comprising an integer number Nb of fixed beacons and defining spatially a field of beacons, each of the acoustic beacons including means for emitting and/or receiving acoustic signals, the device of metrology comprising a mobile, the mobile including means for interrogating and receiving the acoustic signals coming from each of the beacons of the network, respectively,
wherein the device of metrology includes a calculator configured to:
e) receive Nm series of Nb acoustic measurements of relative distance between the mobile and each beacon of the network, respectively, with Nm an integer higher than or equal to three and Nb higher than or equal to three for a two-dimensional calibration, and respectively Nm an integer higher than or equal to eight and Nb higher than or equal to four for a three-dimensional calibration; said series of acoustic measurements being acquired dynamically during a displacement of the mobile to a series of Nm successive positions;
f) calculate a numerical function C as a function, on the one hand, of the series of acoustic measurements of relative distance and, on the other hand, of variables representative of the relative positions of the beacons in the two-dimensional, or respectively three-dimensional, field of beacons;
g) execute an algorithm of minimization of the numerical function C to deduce therefrom an estimation of the values of the variables representative of the relative positions of each of the beacons of the two-dimensional, or respectively three-dimensional, field of beacons; and
h) determine the geometry of the network of beacons as a function of the estimated values of the variables representative of the relative positions of the Nb beacons of the network.

25. The device of metrology according to claim 24, wherein the calculator is further configured to:
i) numerically filter the data of said Nm series of Nb acoustic measurements of relative distance; and
j) interpolate the filtered data of said Nm series of Nb acoustic measurements before calculating the numerical function C.

26. The device of metrology according to claim 24, wherein the calculator is configured to estimate simultaneously the relative position of the mobile and the positions of the beacons at the step of minimization of the numerical function C to allow simultaneously the calibration of the geometry of the network of underwater acoustic beacons and the navigation of the mobile.

27. The device of metrology according to claim 24, further comprising a sensor of depth of immersion of the mobile and means for measuring the difference of depth of immersion between beacons or means for measuring the depth of immersion of each of the beacons.

28. The device of metrology according to claim 24, further comprising a tide gauge or means for calculating the tide amplitude adapted to compensate for the variations of depth of immersion of the mobile and of the beacons as a function of the tides.
